(19) United States
(12) Patent Application Publication
(10) Pub. No.: US 2017/0313599 A1
(43) Pub. Date: Nov. 2, 2017

(54) DESALINATION METHOD USING SUPERABSORBANT POLYMERS

(71) Applicant: Chaitanya Karamchedu, Portland, OR (US)

(72) Inventor: Chaitanya Karamchedu, Portland, OR (US)

(21) Appl. No.: 15/141,551

(22) Filed: Apr. 28, 2016

(51) Int. Cl. C02F 1/28; B01J 20/24; B01J 20/26; C02F 1/00; C02F 1/26; C02F 103/08

(52) U.S. Cl. CPC C02F 1/285; C02F 1/004; C02F 1/265; B01J 20/24; B01J 20/264; C02F 2103/08

(57) ABSTRACT

Method and apparatus for producing desalinated water are disclosed herein. In embodiments, a method may comprise adding superabsorbent polymer to salt water to form a mixture of hydrogel and brine; and extracting desalinated water from the mixture of hydrogel and brine. Other embodiments may be described and claimed.

### TECHNICAL FIELD

The present disclosure relates to the field of desalination. More particularly, the present disclosure relates to desalination method and apparatus using a superabsorbent polymer, such as saponified starch-g-polyacrylamide.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Water scarcity is a global crisis affecting over a billion people; it creates environmental and social stress. Continuing population growth, chemical contamination and pollution and climate change is aggravating this crisis globally.

Desalination has been one of the promising approaches to addressing this crisis. The prospect of extracting arable or potable water from seawater has the potential to impact millions of lives, particularly along the world's coasts. Broadly, current approaches to desalination falls into predominantly membrane based approaches which attempt to create a physical barrier to separate dissolved solids from water or thermal approaches. Examples of membrane technologies include reverse osmosis, nano-filtration, electro-dialysis, electro-dialysis reversal and forward osmosis. Examples of thermal technologies include mutlit-stage flash, multi-effect distillation, vapor compression, and dewvaporization. There are several innovations that use a hybrid approach based on these techniques as well. Examples of these hybrid techniques include freeze desalination, and capacitive deionization. Current approaches are still expensive, both in monetary and energy terms and out of reach for many countries.

And yet, seawater contains only 3%-4% by weight, in terms of salt and other dissolved solids, while the maximum solubility of sodium chloride (NaCl) in water is approximately 30%. This renders nearly 90% of seawater as water that is not bonded with salt and potentially available for harvesting.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates the desalination method/apparatus of the present disclosure, in accordance with various embodiments.

FIG. 2 illustrates various seawater samples and desalinated water recovered, using the desalination process of the present disclosure.

### DETAILED DESCRIPTION

Method and apparatus for producing desalinated water are disclosed herein. In embodiments, a method for desalination may comprise adding superabsorbent polymer to salt water (such as seawater) to form a mixture of hydrogel and brine; and extracting desalinated water from the mixture of hydrogel and brine.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Water forms an ion-dipole bond with the dissolved NaCl. Such a bond causes a hydration shell around the sodium and chlorine ions that are diffused throughout the volume of the water. Water that is not engaged in these hydration shells is pure water. In the absence of selectively targeting either water in these hydration shells or the pure water, one option to desalinate water is to subject the entire volume of water to some form treatment to separate the salt water from the pure water.

Much like the bond between salt and water, certain classes of super absorbent polymers (SAP) forms weak hydrogen bond with water. One such class of SAP is starch grafted polyacrylamide. These polymers contain cross linking chains of —CONH₂ and —COOK which forms a weak hydrogen bond with water molecules to hold the water structurally in a net like structure thus forming a hydrogel.

SAPs have been investigated and commercially deployed for the different uses of their hydrophilicity. A particularly attractive attribute of SAP is its large water holding capacity, and starch-g-polyacrylamide(SG-PAM) has been shown to have a water carrying capacity several hundred times its weight. Another aspect of SAP that has been exploited in drug delivery applications is their sensitivity to pH and their ability to liberate the held fluid when there is a significant alteration in pH. As will be described in more detail below, the method of the present disclosure advantageously leverages on the combination of the hydrophilicity and pH sensitivity of SAP.

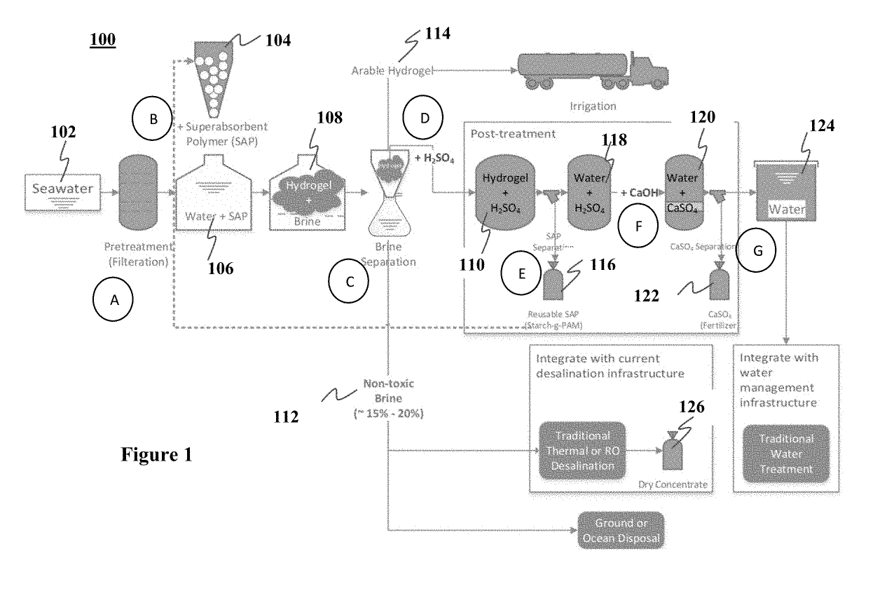

Referring now to FIG. 1, wherein the desalination method and apparatus of the present disclosure, in accordance with various embodiments, is illustrated. As shown, process/system 100 for desalination may include operations performed at stages A through G.

At stage A, seawater 102 may go through pre-treatment, such as filtration, to remove foreign objects, and placed into first one or more containers.

At stage B, superabsorbent polymer (SAP) may be added to seawater 102 to form seawater plus SAP mixture 106. In embodiments, the SAP added to seawater 102 is starch-g-polyacrylamide(SG-PAM). Because water forms a weak hydrogen bonds with sg-PAM and an ion-dipole bond with salt, addition of sg-PAM to seawater 102 results in the initial mixture 106 chemically changed to form mixture 108 where the sg-PAM bonds only with the available unsalted water to form a hydrogel and leaves the salt water as residual brine. In embodiments, an amount of sg-PAM equivalent to about 5% of seawater 102 by weight is added, to form mixture 106/108.

At stage C, the hydrogel and brine in mixture 108 are separated. In embodiments, mixture 108 may be routed through a filtering device to separate the hydrogel and the brine. In embodiments, a filtering device that operates like a Buchner flask may be employed. The extracted hydrogel may be placed into second one or more containers.

At stage D, acid may be added to the extracted hydrogel to form a mixture 110 of hydrogel and acid. As illustrated, in embodiments, sulfuric acid (H₂SO₄) may be used. In embodiments, 10 ml of H₂SO₄ is added per liter of mixture 110. Because the hydrogel stability is pH sensitive and the acid forms a stronger bond with water than the weak hydrogen bond of the gel, the mixture 110 chemically changed into an aqueous solution (not shown) of (H₂SO₄+H₂O)+dehydrated SAP, with the dehydrated SAP precipitated.

At stage E, the dehydrated SAP may be separated from the aqueous solution to produce a mixture 118 of desalinated water plus H₂SO₄, and placed into third one or more containers. Another filter device may be used to remove the precipitated dehydrated SAP. Chemically, the aqueous solution without the dehydrated SAP changes from H₂SO₄+2H₂O→2H₃O⁺+SO₄².

At stage F, calcium hydroxide (Ca(OH)₂) may be added to mixture 118 to produce a mixture 120 of desaliniated water plus calcium sulfate (CaSO₄), with the CaSO₄ precipitated Chemically, 4H₃O⁺+SO₄²⁻+Ca(OH)₂→6H₂O+CaSO4. In embodiments, 10 ml of Ca(OH)₂ is added per liter of mixture 110.

At stage G, CaSO₄ may be separated from mixture 120 to produce desalinated water 124, and placed into fourth one or more containers. Still another filter device may be used to remove the precipitated CaSO₄. Desalinated water 124 stored in the fourth container in turn be potted/bottled for distribution, or fed into a water management infrastructure operated by a municipality or utility, and be integrated with traditional water for treatment, and subsequently make available for usage/consumption.

Back at stage G, the separated CaSO₄ may be processed into fertilizer, packaged and distributed for gardening or farming use.

Back at stage E, the recovered SAP may be reused on desalinating another batch of sale water.

Back at stage C, the separated brine may be disposed or used in current conventional desalination infrastructure. Further, in embodiments, some or all of the hydrogel, in lieu of being further processed to produce desalinated water, may be trucked for irrigation use instead.

Each of the first, second, third and fourth one or more containers mentioned in the above description may be any one of a number of containers made of plastic, metal or other materials. Each of the filtering devices may be any filtering device suitable for separating brine, precipitated SAP or CaSO₄.

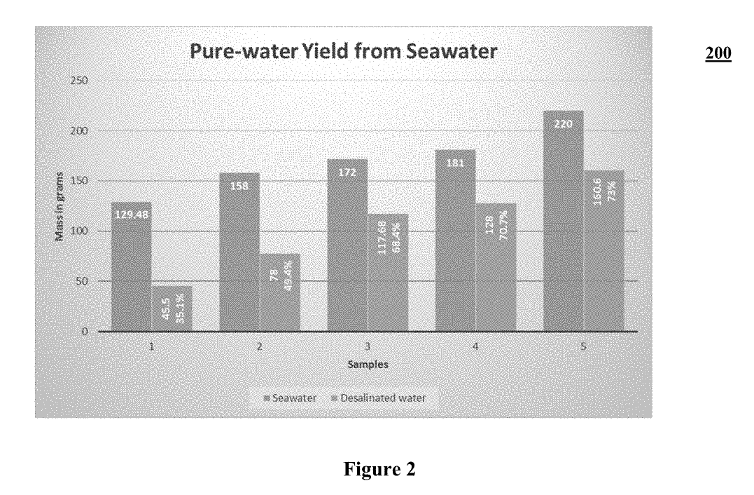

Table I below shows mass (in grams) of various seawater samples and desalinated water recovered using the desalination process of the present disclosure. Table I also shows the amount of SAP used for the various samples, the amount of the mixture of hydrogel plus brine resulted, the amount of post gel brine recovered, and the amount of intervening aqueous solution. FIG. 2 is a graphical illustration of the various seawater samples and desalinated water recovered using the desalination process of the present disclosure.

| | | | | | Aqueous | | |
|---|---|---|---|---|---|---|---|
| | | | Hydrogel + | Post-gel | H₂SO₄ | Desalinated | Recovered |
| | Seawater | SAP | Brine | brine | Solution | water | SAP |
| Sample | (g) | (g) | (g) | (g) | (g) | (g) | (g) |
| 1 | 129.48 | 4.513 | 133.131 | 45.396 | 70.47 | 45.5 | 4.26 |
| 2 | 158 | 7.3 | 164.8 | 20.9 | 114.04 | 78 | 6.88 |
| 3 | 172 | 6.83 | 178.8 | 22.67 | 150.13 | 117.68 | 6.44 |
| 4 | 181 | 7.77 | 188.77 | 23.44 | 157 | 128 | 7.33 |
| 5 | 220 | 11 | 234 | 65 | 101 | 160.6 | 13.2 |

Thus, using the process of the present disclosure, potentially ˜90% of seawater processed may be harvested for irrigation as a hydrogel, or potentially over 70% of seawater processed can be harvested into potable water for human use. No additives were necessary to extract arable and potable water, the consequent lack of chemical contamination of brine mitigates concentrate management requirement. Further, the process requires virtual no external energy (compare with current techniques).

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for producing arable hydrogel or desalinated water, comprising:
adding superabsorbent polymer to salt water to form a mixture of hydrogel and brine; and
extracting arable hydrogel or desalinated water from the mixture of hydrogel and brine.

2. The method of claim 1, wherein adding comprises adding starch-g-polyacrylamide(SG-PAM) to the salt water.

3. The method of claim 1, wherein extracting comprises separating the hydrogel and brine.

4. The method of claim 3, wherein the mixture of hydrogel and brine is a first mixture, and extracting further comprises adding H₂SO₄ to the separated hydrogel to form a second mixture of hydrogel and H₂SO₄.

5. The method of claim 4, wherein extracting further comprises removing the superabsorbent polymer from the second mixture of hydrogel and H₂SO₄ to form a third mixture of water and H₂SO₄.

6. The method of claim 5, wherein extracting further comprises adding Ca(OH)₂ to the third mixture of water and H₂SO₄ to form a fourth mixture of water and CaSO₄.

7. The method of claim 6, wherein extracting further comprises removing CaSO₄ from the fourth mixture of water and CaSO₄ to produce the desalinated water.

8. The method of claim 1, wherein the salt water is seawater.

9. An apparatus for producing arable hydrogel or desalinated water, comprising:
a first container to hold salt water, and for addition of superabsorbent polymer to the salt water to form a mixture of hydrogel and brine; and
a plurality of additional containers to respectively store arable hydrogel, desalinated water, or intervening mixture extracted or generated from the mixture of hydrogel and brine.

10. The apparatus of claim 9, wherein the first container is for addition of starch-g-polyacrylamide(SG-PAM) to the salt water.

11. The apparatus of claim 9, further comprising a filtering device to separate the hydrogel and brine.

12. The apparatus of claim 11, wherein the mixture of hydrogel and brine is a first mixture, and the plurality of additional containers comprises a second container for storage of the separated hydrogel, addition of H₂SO₄ to the separated hydrogel to form a second mixture of hydrogel and H₂SO₄, and storage of the second mixture.

13. The apparatus of claim 12, wherein the filtering device is a first filtering device, and the apparatus further comprises a second filter device to remove the superabsorbent polymer from the second mixture of hydrogel and H₂SO₄ to form a third mixture of water and H₂SO₄, and a third container to store the third mixture.

14. The apparatus of claim 13, wherein the third container is further for addition of Ca(OH)₂ to the third mixture of water and H₂SO₄ to form a fourth mixture of water and CaSO₄, and storage of the fourth mixture.

15. The apparatus of claim 14, further comprising a third filtering device to remove CaSO₄ from the fourth mixture of water and CaSO₄ to produce the desalinated water; and a fourth container to store the desalinated water.

16. The apparatus of claim 9, wherein the salt water is seawater.
